(19) United States
(12) Patent Application Publication
(10) Pub. No.: US 2014/0137016 A1
(43) Pub. Date: May 15, 2014

(54) SELECTION CURSOR OPERATING METHOD, OBJECT DISPLAYING METHOD, AND TERMINAL DEVICE

(71) Applicant: Huawei Technologies Co., Ltd., Shenzhen (CN)

(72) Inventor: Xiangyu Cui, Hangzhou (CN)

(73) Assignee: Huawei Technologies Co., Ltd., Shenzhen (CN)

(21) Appl. No.: 14/143,826

(22) Filed: Dec. 30, 2013

Related U.S. Application Data
(63) Continuation of application No. PCT/CN2013/072069, filed on Mar. 1, 2013.

(30) Foreign Application Priority Data
Mar. 26, 2012 (CN) 201210081928.8

(51) Int. Cl. G06F 3/0482; G06F 3/0484; G06F 3/0487; G06F 3/0481

(52) U.S. Cl. CPC G06F 3/0482; G06F 3/04812; G06F 3/04842; G06F 3/0487
USPC 715/765

(57) ABSTRACT

Embodiments of the present invention provide a selection cursor operating method, an object displaying method, and a terminal device. By displaying selectable objects on a display device and generating a selection cursor, where the boundary defines a selection area of the selection cursor, and the selection area is used to select at least one of the selectable objects, the embodiments of the present invention can adjust on a boundary parameter of the boundary of the selection cursor, or the determination of the position of the selection cursor on the display device, and the selection of at least one of the selectable objects nearest to the selection cursor according to the determined position of the selection cursor on the display device. Therefore, the problem of low accuracy and low efficiency in screen positioning in the prior art is avoided and the accuracy and efficiency in object selection are improved.

### CROSS-REFERENCE TO RELATED APPLICATIONS

This application is a continuation of International Application No. PCT/CN2013/072069, filed on Mar. 1, 2013, which claims priority to Chinese Patent Application No. 201210081928.8, filed on Mar. 26, 2012, both of which are hereby incorporated by reference in their entireties.

### TECHNICAL FIELD

The present invention relates to position control technologies, and in particular, to a selection cursor operating method, an object displaying method, and a terminal device.

### BACKGROUND

During the interaction between a terminal device and a user, the position information of a screen of the terminal device is always needed for selecting an object in a certain position of the screen. Since the screen of the terminal device and the user are away from each other by a certain distance, the terminal device needs to adjust the position of a cursor through an input device, such as a navigation key, a mouse, a track ball, a joystick, or a touch pad, so as to obtain the position information of the screen of the terminal device.

However, technical solutions adopted by the prior art may lower the accuracy and efficiency in screen positioning, further causing the decrease of the accuracy and efficiency in object selection.

### SUMMARY

Embodiments of the present invention provide a selection cursor operating method, an object displaying method, and a terminal device, so as to improve the accuracy and efficiency in object selection.

In one aspect, a selection cursor operating method is provided, including:

displaying a plurality of selectable objects on a display device;

generating a selection cursor which is displayed on the display device and includes a boundary, where the boundary defines a selection area of the selection cursor, and the selection area is used to select at least one of the selectable objects; and

adjusting a boundary parameter of the boundary of the selection cursor to enable the size of the selection area defined by the boundary to match the size of geometrical shapes of the plurality of selectable objects displayed on the display device, or to match the distribution density of the plurality of selectable objects on the display device.

In another aspect, an object displaying method is provided, including:

displaying a plurality of selectable objects on a display device;

generating a selection cursor which is displayed on the display device and includes a boundary, where the boundary defines a selection area of the selection cursor, and the selection area is used to select at least one of the selectable objects;

determining the position of the selection cursor on the display device, and selecting at least one of the selectable objects nearest to the selection cursor according to the determined position of the selection cursor on the display device; and

adjusting a geometrical shape of the at least one of the selectable objects displayed on the display device to enable the size of the geometrical shape of the at least one of the selectable objects displayed on the display device to match the size of the selection area defined by the boundary.

In another aspect, a terminal device is provided, including:

a displaying unit, configured to display a plurality of selectable objects on a display device;

a generating unit, configured to generate a selection cursor which is displayed on the display device and includes a boundary, where the boundary defines a selection area of the selection cursor, and the selection area is used to select at least one of the selectable objects; and

an adjusting unit, configured to adjust a boundary parameter of the boundary of the selection cursor to enable the size of the selection area defined by the boundary to match the size of geometrical shapes of the plurality of selectable objects displayed on the display device, or to match the distribution density of the plurality of selectable objects on the display device.

In another aspect, a terminal device is provided, including:

a displaying unit, configured to display a plurality of selectable objects on a display device;

a generating unit, configured to generate a selection cursor which is displayed on the display device and includes a boundary, where the boundary defines a selection area of the selection cursor, and the selection area is used to select at least one of the selectable objects; and

an adjusting unit, configured to determine the position of the selection cursor on the display device, select at least one of the selectable objects nearest to the selection cursor according to the determined position of the selection cursor on the display device, and adjust a geometrical shape of the at least one of the selectable objects displayed on the display device to enable the size of the geometrical shape of the at least one of the selectable objects displayed on the display device to match the size of the selection area defined by the boundary.

It can be known from the foregoing technical solutions that, by displaying a plurality of selectable objects on a display device and generating a selection cursor which is displayed on the display device and includes a boundary, where the boundary defines a selection area of the selection cursor, and the selection area is used to select at least one of the selectable objects, the embodiments of the present invention can adjust on a boundary parameter of the boundary of the selection cursor, so that the size of the selection area defined by the boundary can match the size of geometrical shapes of the plurality of selectable objects displayed on the display device, or match the distribution density of the plurality of selectable objects on the display device, thereby avoiding the problem of low accuracy and low efficiency in screen positioning in the prior art and improving the accuracy and efficiency in object selection.

It can be known from the foregoing technical solutions that, by displaying a plurality of selectable objects on a display device, generating a selection cursor which is displayed on the display device and includes a boundary, where the boundary defines a selection area of the selection cursor, and the selection area is used to select at least one of the selectable objects, then determining the position of the selection cursor on the display device, and selecting at least one of the selectable objects nearest to the selection cursor according to the determined position of the selection cursor on the display device, the embodiments of the present invention can adjust on a geometrical shape of the at least one of the selectable objects displayed on the display device, so that the size of the geometrical shape of the at least one of the selectable objects displayed on the display device can match the size of the selection area defined by the boundary, thereby avoiding the problem of low accuracy and low efficiency in screen positioning in the prior art and improving the accuracy and efficiency in object selection.

### BRIEF DESCRIPTION OF DRAWINGS

To illustrate the technical solutions in the embodiments of the present invention or in the prior art more clearly, the accompanying drawings required for describing the embodiments or the prior art are briefly described in the following. Apparently, the accompanying drawings in the following description merely show some embodiments of the present invention, and persons of ordinary skill in the art may still derive other drawings from these accompanying drawings without creative efforts.

FIG. 1 is a schematic flowchart of a selection cursor operating method according to an embodiment of the present invention;

FIG. 2 is a schematic diagram of selectable objects and a selection cursor which are on a screen of a terminal device according to the embodiment corresponding to FIG. 1;

FIG. 3 is another schematic diagram of selectable objects and a selection cursor which are on a screen of a terminal device according to the embodiment corresponding to FIG. 1;

FIG. 4 is another schematic diagram of selectable objects and a selection cursor which are on a screen of a terminal device according to the embodiment corresponding to FIG. 1;

FIG. 5 is another schematic diagram of selectable objects and a selection cursor which are on a screen of a terminal device according to the embodiment corresponding to FIG. 1;

FIG. 6 is a schematic flowchart of an object displaying method according to another embodiment of the present invention;

FIG. 7 is a schematic structural diagram of a terminal device according to another embodiment of the present invention;

FIG. 8 is a schematic structural diagram of a terminal device according to another embodiment of the present invention;

FIG. 9 is a schematic structural diagram of a terminal device according to another embodiment of the present invention; and

FIG. 10 is a schematic structural diagram of a terminal device according to another embodiment of the present invention.

### DESCRIPTION OF EMBODIMENTS

To make the objectives, technical solutions, and advantages of the embodiments of the present invention more clearly, the following clearly and describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

It should be noted that, a terminal device involved in embodiments of the present invention includes but is not limited to a mobile phone, an MP3 player, an MP4 player, a personal digital assistant (Personal Digital Assistant, PDA for short), a wireless handheld device, a personal computer, a television set, or the like.

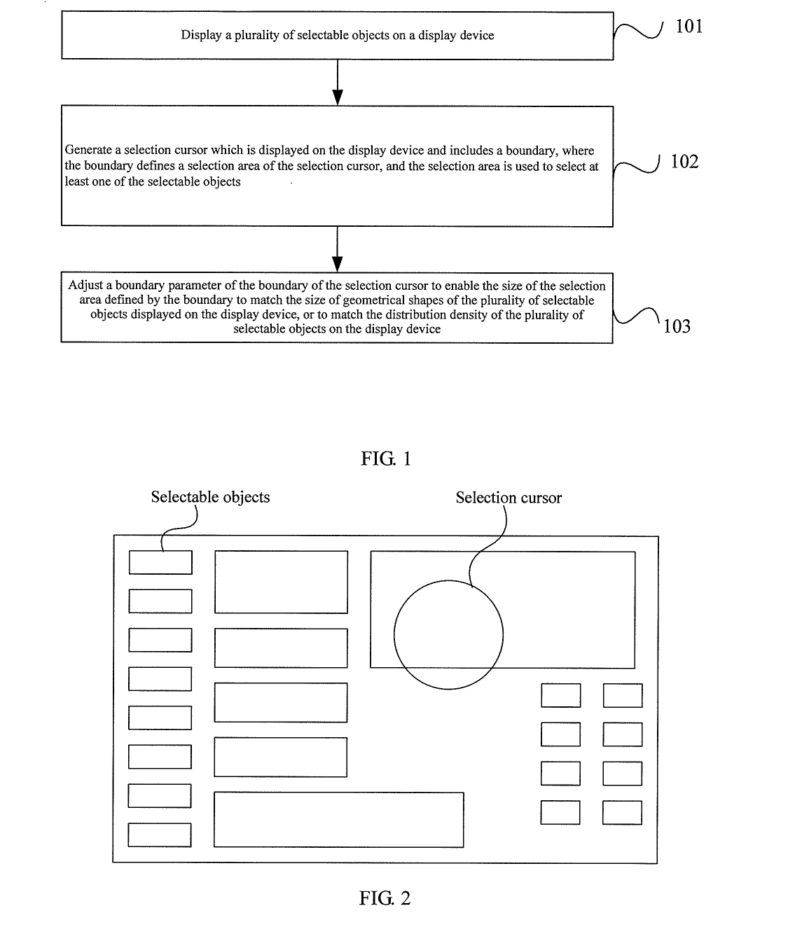

FIG. 1 is a schematic flowchart of an object selection method according to an embodiment of the present invention. As shown in FIG. 1, the object selection method according to this embodiment may include:

101: Display a plurality of selectable objects on a display device.

102: Generate a selection cursor which is displayed on the display device and includes a boundary, where the boundary defines a selection area of the selection cursor, and the selection area is used to select at least one of the selectable objects.

The transparency of the selection area defined by the boundary may be in a range from 0 to 100%.

103: Adjust a boundary parameter of the boundary of the selection cursor to enable the size of the selection area defined by the boundary to match the size of geometrical shapes of the plurality of selectable objects displayed on the display device, or to match the distribution density of the plurality of selectable objects on the display device.

The boundary parameter of the boundary may include but is not limited to at least one of the length of the boundary and a shape of the boundary.

The executor of the foregoing 101 to 103 may be a terminal device.

In an optional implementation manner of this embodiment, in 103, the terminal device may specifically obtain a displayed geometrical shape of one or more selectable objects in a specified range corresponding to the position of the selection cursor on the display device, and then the terminal device further adjusts the size of the selection area according to the geometrical shape. For example, the terminal device may adjust the size of the selection area to the size of the obtained geometrical shape.

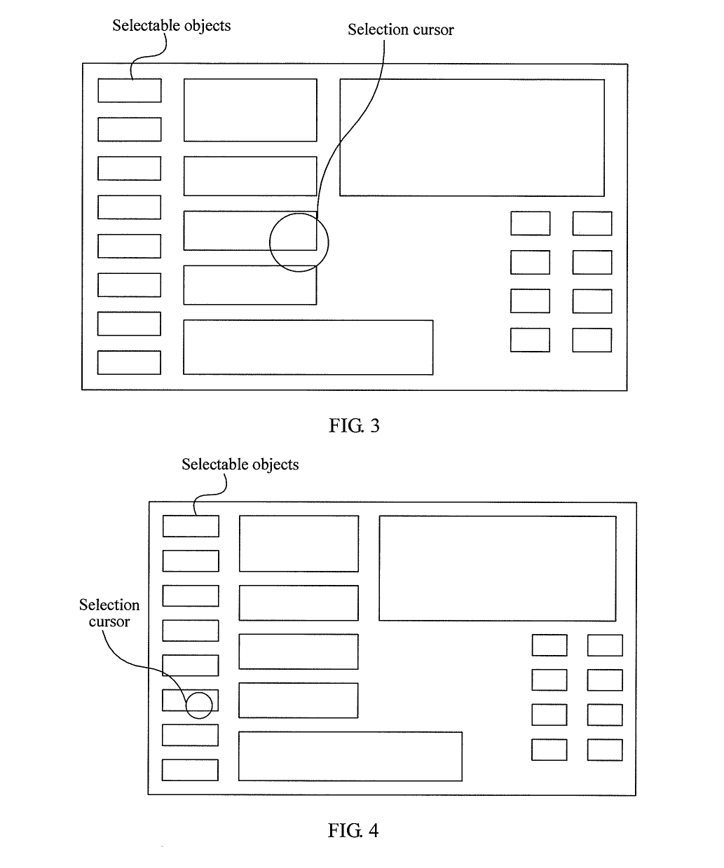

In an optional implementation manner of this embodiment, in 103, the terminal device may specifically obtain the distribution density of the selectable objects in a specified range corresponding to the position of the selection cursor on the display device, and then the terminal device further adjusts the size of the selection area according to the distribution density. For example, the terminal device may obtain, according to the correspondence between the distribution density and the area size, as well as the distribution density, an area size corresponding to the distribution density, and adjust the size of the selection area to the obtained area size corresponding to the distribution density as shown in FIG. 2 to FIG. 4. It can be seen that, with the increase of the density, the terminal device may gradually decrease the area size of the selection area.

In an optional implementation manner of this embodiment, the terminal device may further move the selection cursor and select a selectable object which overlaps the selection cursor and meets a preset selection standard. The selection standard may indicate that an overlapping area between the selectable object and the selection cursor is larger than or equal to a specified threshold. For example, if the selection cursor overlaps a selectable object A, the terminal device may specifically select the object A according to a selection instruction input by a user; or if the selection cursor overlaps two selectable objects A and B, where a covered area of the object A is larger than the specified threshold, the terminal device may specifically select the object A according to a selection instruction input by a user.

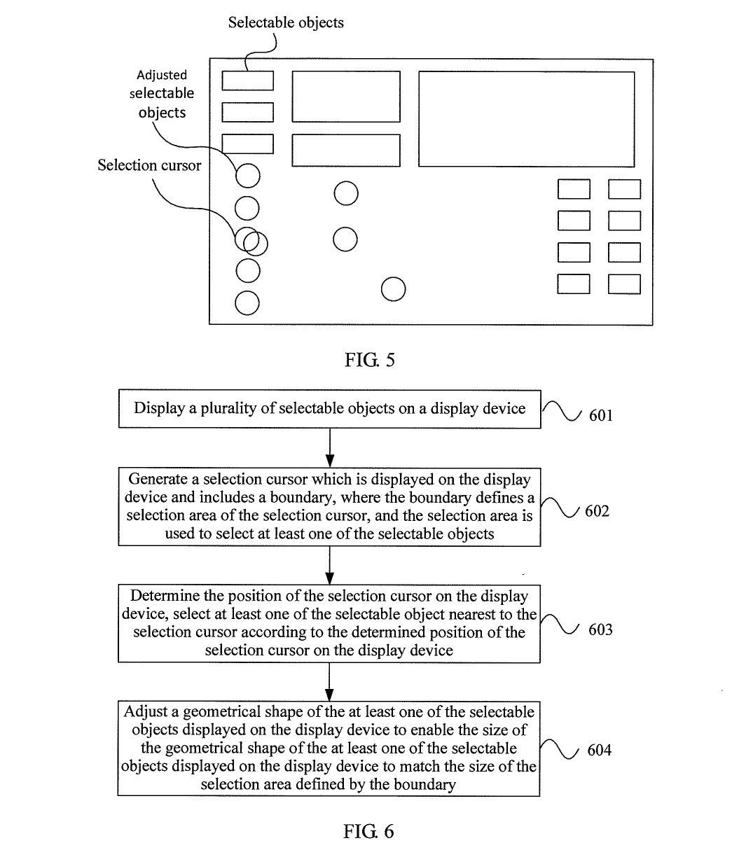

In an optional implementation manner of this embodiment, the terminal device may further determine the position of the selection cursor on the display device, select at least one of the selectable objects nearest to the selection cursor according to the determined position of the selection cursor on the display device, and then the terminal device adjusts a geometrical shape of the at least one of the selectable objects displayed on the display device to enable the size of the geometrical shape of the at least one of the selectable objects displayed on the display device to match the size of the selection area defined by the boundary as shown in FIG. 5.

In this embodiment, by displaying a plurality of selectable objects on a display device and generating a selection cursor which is displayed on the display device and includes a boundary, where the boundary defines a selection area of the selection cursor, and the selection area is used to select at least one of the selectable objects, an adjustment can be performed on a boundary parameter of the boundary of the selection cursor, so that the size of the selection area defined by the boundary can match the size of geometrical shapes of the plurality of selectable objects displayed on the display device, or match the distribution density of the plurality of selectable objects on the display device, thereby avoiding the problem of low accuracy and low efficiency in screen positioning in the prior art and improving the accuracy and efficiency in object selection.

FIG. 6 is a schematic flowchart of an object displaying method according to another embodiment of the present invention. As shown in FIG. 6, the object displaying method according to this embodiment may include:

601: Display a plurality of selectable objects on a display device.

602: Generate a selection cursor which is displayed on the display device and includes a boundary, where the boundary defines a selection area of the selection cursor, and the selection area is used to select at least one of the selectable objects.

The transparency of the selection area defined by the boundary may be in a range from 0 to 100%.

603: Determine the position of the selection cursor on the display device, and select at least one of the selectable objects nearest to the selection cursor according to the determined position of the selection cursor on the display device.

604: Adjust a geometrical shape of the at least one of the selectable objects displayed on the display device to enable the size of the geometrical shape of the at least one of the selectable objects displayed on the display device to match the size of the selection area defined by the boundary.

The executor of the foregoing 601 to 604 may be a terminal device. Reference may be made to FIG. 5 for the schematic diagram of the selectable objects and the selection cursor which are on a screen of the terminal device in this embodiment, and no description will be further provided herein again.

In an optional implementation manner of this embodiment, the terminal device may further adjust a boundary parameter of the boundary of the selection cursor to enable the size of the selection area defined by the boundary to match the size of geometrical shapes of the plurality of selectable objects displayed on the display device, or to match the distribution density of the plurality of selectable objects on the display device. The boundary parameter of the boundary may include but is not limited to at least one of a length of the boundary and a shape of the boundary.

For example, the terminal device may specifically obtain a displayed geometrical shape of one or more selectable objects in a specified range corresponding to the position of the selection cursor on the display device, and then the terminal device further adjusts the size of the selection area according to the geometrical shape. For example, the terminal device may adjust the size of the selection area to the size of the obtained geometrical shape.

For example, the terminal device may specifically obtain the distribution density of the selectable objects in a specified range corresponding to the position of the selection cursor on the display device, and then the terminal device further adjusts the size of the selection area according to the distribution density. For example, the terminal device may obtain, according to the correspondence between the distribution density and the area size, as well as the distribution density, an area size corresponding to the distribution density, and adjust the size of the selection area to the obtained area size corresponding to the distribution density. Reference may be made to FIG. 2 to FIG. 4 for the schematic diagram of the selectable objects and the selection cursor which are on the screen of the terminal device in this embodiment. It can be seen that, with the increase of the density, the terminal device may gradually decrease the area size of the selection area.

In an optional implementation manner of this embodiment, the terminal device may further move the selection cursor and select a selectable object which overlaps the selection cursor and meets a preset selection standard. The selection standard may indicate that an overlapping area between the selectable object and the selection cursor is larger than or equal to a specified threshold. For example, if the selection cursor overlaps a selectable object A, the terminal device may specifically select the object A according to a selection instruction input by a user; or if the selection cursor overlaps two selectable objects A and B, where a covered area of the object A is larger than the specified threshold, the terminal device may specifically select the object A according to a selection instruction input by a user.

In this embodiment, by displaying a plurality of selectable objects on a display device, generating a selection cursor which is displayed on the display device and includes a boundary, where the boundary defines a selection area of the selection cursor, and the selection area is used to select at least one of the selectable object, then determining the position of the selection cursor on the display device, and selecting at least one of the selectable objects nearest to the selection cursor according to the determined position of the selection cursor on the display device, an adjustment can be performed on a geometrical shape of the at least one of the selectable objects displayed on the display device, so that the size of the geometrical shape of the at least one of the selectable objects displayed on the display device can match the size of the selection area defined by the boundary, thereby avoiding the problem of low accuracy and low efficiency in screen positioning in the prior art and improving the accuracy and efficiency in object selection.

It should be noted that, for the brevity, the foregoing method embodiments are represented as a series of action combinations. However, persons skilled in the art should know that, the present invention is not limited to the sequence of the described actions, because according to the present invention, some steps may be performed by adopting other sequences or performed simultaneously. Secondly, persons skilled in the art should also know that, the embodiments described in the specification all belong to exemplary embodiments, and the related actions and modules are not necessarily required by the present invention.

In the foregoing embodiments, the description of each embodiment has respective focuses. For a part that is not described in detail in a certain embodiment, reference may be made to related descriptions in other embodiments.

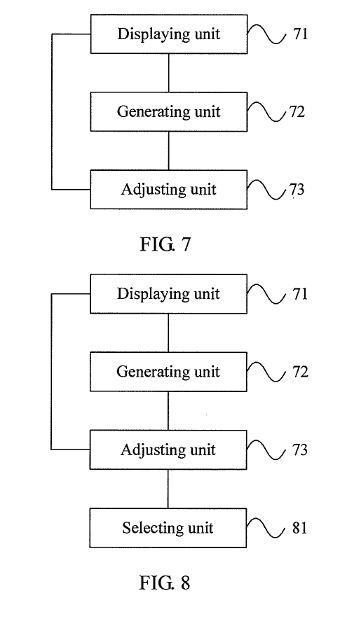

FIG. 7 is a schematic structural diagram of a terminal device according to another embodiment of the present invention. As shown in FIG. 7, the terminal device according to this embodiment may include a displaying unit 71, a generating unit 72, and an adjusting unit 73. The displaying unit 71 is configured to display a plurality of selectable objects on a display device; the generating unit 72 is configured to generate a selection cursor which is displayed on the display device and includes a boundary, where the boundary defines a selection area of the selection cursor, and the selection area is used to select at least one of the selectable objects; and the adjusting unit 73 is configured to adjust a boundary parameter of the boundary of the selection cursor to enable the size of the selection area defined by the boundary to match the size of geometrical shapes of the plurality of selectable objects displayed on the display device, or to match the distribution density of the plurality of selectable objects on the display device.

The transparency of the selection area defined by the boundary may be in a range from 0 to 100%.

The boundary parameter of the boundary may include but is not limited to at least one of the length of the boundary and a shape of the boundary.

In an optional implementation manner of this embodiment, the adjusting unit 73 may specifically obtain a displayed geometrical shape of one or more selectable objects in a specified range corresponding to the position of the selection cursor on the display device, and then further adjust the size of the selection area according to the geometrical shape. For example, the adjusting unit 73 may specifically adjust the size of the selection area to the size of the obtained geometrical shape.

In an optional implementation manner of this embodiment, the adjusting unit 73 may specifically obtain the distribution density of the selectable objects in a specified range corresponding to the position of the selection cursor on the display device, and then further adjust the size of the selection area according to the distribution density. For example, the adjusting unit 73 may specifically obtain, according to the correspondence between the distribution density and the area size, as well as the distribution density, an area size corresponding to the distribution density, and adjust the size of the selection area to the obtained area size corresponding to the distribution density. Reference may be made to FIG. 2 to FIG. 4 for the schematic diagram of the selectable objects and the selection cursor which are on a screen of the terminal device in this embodiment. It can be seen that, with the increase of the density, the adjusting unit 73 may gradually decrease the area size of the selection area.

In an optional implementation manner of this embodiment, as shown in FIG. 8, the terminal device according to this embodiment may further include a selecting unit 81, configured to move the selection cursor and select a selectable object which overlaps the selection cursor and meets a preset selection standard. The selection standard may indicate that an overlapping area between the selectable object and the selection cursor is larger than or equal to a specified threshold.

In an optional implementation manner of this embodiment, the adjusting unit 73 may be further configured to determine the position of the selection cursor on the display device, select at least one of the selectable objects nearest to the selection cursor according to the determined position of the selection cursor on the display device, and adjust a geometrical shape of the at least one of the selectable objects displayed on the display device to enable the size of the geometrical shape of the at least one of the selectable objects displayed on the display device to match the size of the selection area defined by the boundary. Reference may be made to FIG. 5 for the schematic diagram of the selectable objects and the selection cursor which are on a screen of the terminal device in this embodiment, and no description will be further provided herein again.

In this embodiment, a terminal device adopts a displaying unit to display a plurality of selectable objects on a display device and a generating unit to generate a selection cursor which is displayed on the display device and includes a boundary, where the boundary defines a selection area of the selection cursor, and the selection area is used to select at least one of the selectable objects. Therefore, an adjusting unit can adjust on a boundary parameter of the boundary of the selection cursor, so that the size of the selection area defined by the boundary can match the size of geometrical shapes of the plurality of selectable objects displayed on the display device, or to match the distribution density of the plurality of selectable objects on the display device, thereby avoiding the problem of low accuracy and low efficiency in screen positioning in the prior art and improving the accuracy and efficiency in object selection.

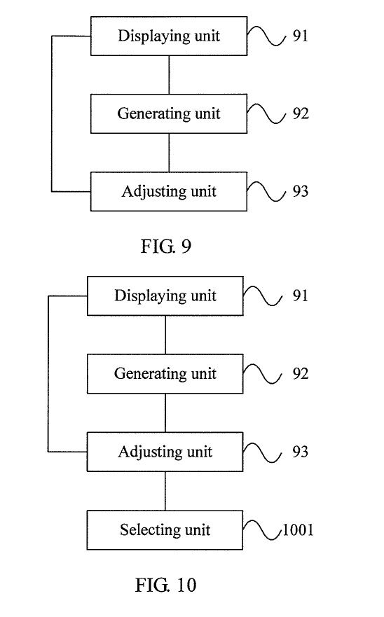

FIG. 9 is a schematic structural diagram of a terminal device according to another embodiment of the present invention. As shown in FIG. 9, the terminal device according to this embodiment may include a displaying unit 91, a generating unit 92, and an adjusting unit 93. The displaying unit 91 is configured to display a plurality of selectable objects on a display device; the generating unit 92 is configured to generate a selection cursor which is displayed on the display device and includes a boundary, where the boundary defines a selection area of the selection cursor, and the selection area is used to select at least one of the selectable objects; and the adjusting unit 93 is configured to determine the position of the selection cursor on the display device, select at least one of the selectable objects nearest to the selection cursor according to the determined position of the selection cursor on the display device, and adjust a geometrical shape of the at least one of the selectable objects displayed on the display device to enable the size of the geometrical shape of the at least one of the selectable objects displayed on the display device to match the size of the selection area defined by the boundary.

Reference may be made to FIG. 5 for the schematic diagram of the selectable objects and the selection cursor which are on a screen of the terminal device in this embodiment, and no description will be further provided herein again.

In an optional implementation manner of this embodiment, the adjusting unit 93 may be further configured to adjust a boundary parameter of the boundary of the selection cursor to enable the size of the selection area defined by the boundary to match the size of geometrical shapes of the plurality of selectable objects displayed on the display device, or to match the distribution density of the plurality of selectable objects on the display device.

The transparency of the selection area defined by the boundary may be in a range from 0 to 100%.

The boundary parameter of the boundary may include but is not limited to at least one of the length of the boundary and a shape of the boundary.

For example, the adjusting unit 93 may specifically obtain a displayed geometrical shape of one or more selectable objects in a specified range corresponding to the position of the selection cursor on the display device, and then further adjust the size of the selection area according to the geometrical shape. For example, the adjusting unit 93 may specifically adjust the size of the selection area to the size of the obtained geometrical shape.

For example, the adjusting unit 93 may specifically obtain the distribution density of the selectable objects in a specified range corresponding to the position of the selection cursor on the display device, and then further adjust the size of the selection area according to the distribution density. For example, the adjusting unit 93 may specifically obtain, according to the correspondence between the distribution density and the area size, as well as the distribution density, an area size corresponding to the distribution density, and adjust the size of the selection area to the obtained area size corresponding to the distribution density. Reference may be made to FIG. 2 to FIG. 4 for the schematic diagram of the selectable objects and the selection cursor which are on the screen of the terminal device in this embodiment. It can be seen that, with the increase of the density, the adjusting unit 93 may gradually decrease the area size of the selection area.

In an optional implementation manner of this embodiment, as shown in FIG. 10, the terminal device according to this embodiment may further include a selecting unit 1001, configured to move the selection cursor and select a selectable object which overlaps the selection cursor and meets a preset selection standard. The selection standard may indicate that an overlapping area between the selectable object and the selection cursor is larger than or equal to a specified threshold.

In this embodiment, a terminal device adopts a displaying unit to display a plurality of selectable objects on a display device, a generating unit to generate a selection cursor which is displayed on the display device and includes a boundary, where the boundary defines a selection area of the selection cursor, and the selection area is used to select at least one of the selectable objects, and then an adjusting unit to determine the position of the selection cursor on the display device, and select at least one of the selectable objects nearest to the selection cursor according to the determined position of the selection cursor on the display device, so that the adjusting unit can perform an adjustment on a geometrical shape of the at least one of the selectable objects displayed on the display device to enable the size of the geometrical shape of the at least one of the selectable objects displayed on the display device to match the size of the selection area defined by the boundary, thereby avoiding the problem of low accuracy and low efficiency in screen positioning in the prior art and improving the accuracy and efficiency in object selection.

Persons skilled in the art may clearly understand that, for the purpose of convenient and brief description, for a detailed working process of the foregoing system, apparatus and unit, reference may be made to the corresponding process in the method embodiments, and the details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces; and the indirect couplings or communication connections between the apparatuses or units may be implemented in electronic, mechanical, or other forms.

The units described as separate parts may or may not be physically separate, and parts displayed as units may or may not be physical units, and may be located in one position, or may be distributed on a plurality of network units. A part or all of the units may be selected according to an actual need to achieve the objectives of the solutions of the embodiments.

In addition, various functional units in the embodiments of the present invention may be integrated into one processing unit, or may exist physically as separate units, or two or more units are integrated into one unit. The integrated unit may be implemented through hardware, or may also be implemented in a form of hardware plus a software functional unit.

The integrated unit implemented in the form of software functional unit may be stored in a computer readable storage medium. The software functional unit is stored in a storage medium, and includes several instructions for instructing a computer device (which may be a personal computer, a server, a network device, or the like) to perform a part of the steps of the methods described in the embodiments of the present invention. The storage medium includes any medium that can store program codes, such as a USB flash drive, a removable hard disk, a read-only memory (Read-Only memory, ROM for short), a random access memory (Random Access Memory, RAM for short), a magnetic disk, or an optical disk.

Finally, it should be noted that, the foregoing embodiments are merely intended for describing the technical solutions of the present invention rather than limiting the present invention. Although the present invention is described in detail with reference to the foregoing embodiments, persons of ordinary skill in the art should understand that, they may still make modifications to the technical solution described in the foregoing embodiments or make equivalent replacements to some technical features thereof, as long as these modifications or replacements do not make the essence of corresponding technical solutions depart from the spirit and scope of the technical solutions of the embodiments of the present invention.

What is claimed is:

1. A selection cursor operating method, comprising:
displaying a plurality of selectable objects on a display device;
generating a selection cursor which is displayed on the display device and comprises a boundary, wherein the boundary defines a selection area of the selection cursor, and the selection area is used to select at least one of the selectable objects; and
adjusting a boundary parameter of the boundary of the selection cursor to enable the size of the selection area defined by the boundary to match the size of geometrical shapes of the plurality of selectable objects displayed on the display device, or to match the distribution density of the plurality of selectable objects on the display device.

2. The method according to claim 1, wherein the transparency of the selection area defined by the boundary is in a range from 0 to 100%.

3. The method according to claim 1, wherein adjusting a boundary parameter of the boundary of the selection cursor comprises:
obtaining a displayed geometrical shape of one or more selectable objects in a specified range corresponding to the position of the selection cursor on the display device; and
adjusting the size of the selection area according to the geometrical shape.

4. The method according to claim 1, wherein adjusting a boundary parameter of the boundary of the selection cursor comprises:
obtaining the distribution density of the selectable objects in a specified range corresponding to the position of the selection cursor on the display device; and
adjusting the size of the selection area according to the distribution density.

5. The method according to claim 4, wherein adjusting the size of the selection area according to the distribution density comprises:
obtaining, according to the correspondence between the distribution density and the area size, as well as the distribution density, an area size corresponding to the distribution density; and
adjusting the size of the selection area to the obtained area size corresponding to the distribution density.

6. The method according to claim 1, further comprising:
determining the position of the selection cursor on the display device, and selecting at least one of the selectable objects nearest to the selection cursor according to the determined position of the selection cursor on the display device; and
adjusting a geometrical shape of the at least one of the selectable objects displayed on the display device to enable the size of the geometrical shape of the at least one of the selectable objects displayed on the display device to match the size of the selection area defined by the boundary.

7. An object displaying method, comprising:
displaying a plurality of selectable objects on a display device;
generating a selection cursor which is displayed on the display device and comprises a boundary, wherein the boundary defines a selection area of the selection cursor, and the selection area is used to select at least one of the selectable objects;
determining the position of the selection cursor on the display device, and selecting at least one of the selectable objects nearest to the selection cursor according to the determined position of the selection cursor on the display device; and
adjusting a geometrical shape of the at least one of the selectable objects displayed on the display device to enable the size of the geometrical shape of the at least one of the selectable objects displayed on the display device to match the size of the selection area defined by the boundary.

8. The method according to claim 7, further comprising:
adjusting a boundary parameter of the boundary of the selection cursor to enable the size of the selection area defined by the boundary to match the size of geometrical shapes of the plurality of selectable objects displayed on the display device, or to match the distribution density of the plurality of selectable objects on the display device.

9. The method according to claim 7, wherein the transparency of the selection area defined by the boundary is in a range from 0 to 100%.

10. The method according to claim 8, wherein adjusting a boundary parameter of the boundary of the selection cursor comprises:
obtaining a displayed geometrical shape of one or more selectable objects in a specified range corresponding to the position of the selection cursor on the display device; and
adjust the size of the selection area according to the geometrical shape.

11. The method according to claim 8, wherein adjusting a boundary parameter of the boundary of the selection cursor comprises:
obtaining the distribution density of the selectable objects in a specified range corresponding to the position of the selection cursor on the display device; and
adjusting the size of the selection area according to the distribution density.

12. The method according to claim 11, wherein adjusting the size of the selection area according to the distribution density comprises:
obtaining, according to the correspondence between the distribution density and the area size, as well as the distribution density, an area size corresponding to the distribution density; and
adjusting the size of the selection area to the obtained area size corresponding to the distribution density.

13. A terminal device, comprising:
a displaying unit, configured to display a plurality of selectable objects on a display device;
a generating unit, configured to generate a selection cursor which is displayed on the display device and comprises a boundary, wherein the boundary defines a selection area of the selection cursor, and the selection area is used to select at least one of the selectable objects; and
an adjusting unit, configured to adjust a boundary parameter of the boundary of the selection cursor to enable the size of the selection area defined by the boundary to match the size of geometrical shapes of the plurality of selectable objects displayed on the display device, or to match the distribution density of the plurality of selectable objects on the display device.

14. The terminal device according to claim 13, wherein the transparency of the selection area defined by the boundary is in a range from 0 to 100%.

15. The terminal device according to claim 13, wherein the adjusting unit is configured to:
obtain a displayed geometrical shape of one or more selectable objects in a specified range corresponding to the position of the selection cursor on the display device; and
adjust the size of the selection area according to the geometrical shape.

16. The terminal device according to claim 13, wherein the adjusting unit is configured to:
obtain the distribution density of the selectable objects in a specified range corresponding to the position of the selection cursor on the display device; and
adjust the size of the selection area according to the distribution density.

17. The terminal device according to claim 16, wherein the adjusting unit is configured to:
obtain, according to the correspondence between the distribution density and the area size, as well as the distribution density, an area size corresponding to the distribution density; and
adjust the size of the selection area to the obtained area size corresponding to the distribution density.

18. The terminal device according to claim 13, further comprising a selecting unit configured to:
move the selection cursor and select a selectable object which overlaps the selection cursor and meets a preset selection standard; wherein the selection standard indicates that an overlapping area between the selectable object and the selection cursor is larger than or equal to a specified threshold.

19. The terminal device according to claim 13, wherein the adjusting unit is further configured to:
determine the position of the selection cursor on the display device, select at least one of the selectable objects nearest to the selection cursor according to the determined position of the selection cursor on the display device, and adjust a geometrical shape of the at least one of the selectable objects displayed on the display device to enable the size of the geometrical shape of the at least one of the selectable objects displayed on the display device to match the size of the selection area defined by the boundary.

20. A terminal device, comprising:
a displaying unit, configured to display a plurality of selectable objects on a display device;
a generating unit, configured to generate a selection cursor which is displayed on the display device and comprises a boundary, wherein the boundary defines a selection area of the selection cursor, and the selection area is used to select at least one of the selectable objects; and
an adjusting unit, configured to determine the position of the selection cursor on the display device, select at least one of the selectable objects nearest to the selection cursor according to the determined position of the selection cursor on the display device, and adjust a geometrical shape of the at least one of the selectable objects displayed on the display device to enable the size of the geometrical shape of the at least one of the selectable objects displayed on the display device to match the size of the selection area defined by the boundary.

21. The terminal device according to claim 20, wherein the adjusting unit is further configured to:
adjust a boundary parameter of the boundary of the selection cursor to enable the size of the selection area defined by the boundary to match the size of geometrical shapes of the plurality of selectable objects displayed on the display device, or to match the distribution density of the plurality of selectable objects on the display device.

22. The terminal device according to claim 20, wherein the transparency of the selection area defined by the boundary is in a range from 0 to 100%.

23. The terminal device according to claim 21, wherein the adjusting unit is configured to:
obtain a displayed geometrical shape of one or more selectable objects in a specified range corresponding to the position of the selection cursor on the display device; and
adjust the size of the selection area according to the geometrical shape.

24. The terminal device according to claim 23, wherein the adjusting unit is configured to:
adjust the size of the selection area to the size of the obtained geometrical shape.

25. The terminal device according to claim 21, wherein the adjusting unit is configured to:
obtain the distribution density of the selectable objects in a specified range corresponding to the position of the selection cursor on the display device; and
adjust the size of the selection area according to the distribution density.

26. The terminal device according to claim 25, wherein the adjusting unit is configured to:
obtain, according to the correspondence between the distribution density and the area size, as well as the distribution density, an area size corresponding to the distribution density; and
adjust the size of the selection area to the obtained area size corresponding to the distribution density.

27. The terminal device according to claim 20, further comprising a selecting unit configured to:
move the selection cursor and select a selectable object which overlaps the selection cursor and meets a preset selection standard
wherein the selection standard indicates that an overlapping area between the selectable object and the selection cursor is larger than or equal to a specified threshold.
